(19) United States
(12) Patent Application Publication
(10) Pub. No.: US 2025/0139416 A1
(43) Pub. Date: May 1, 2025

(54) NEURAL NETWORK COMPUTING METHOD, PROCESSOR AND DEVICE THEREOF

(71) Applicant: Smarter Silicon (Shanghai) Technologies Co., Ltd., Shanghai (CN)

(72) Inventor: Yao MA, Shanghai (CN)

(21) Appl. No.: 18/921,817

(22) Filed: Oct. 21, 2024

(30) Foreign Application Priority Data
Oct. 31, 2023 (CN) 202311437274.2

(51) Int. Cl. G06N 3/0464

(52) U.S. Cl. CPC G06N 3/0464

(57) ABSTRACT

A neural network calculation method, including: determining calculation parameters of convolutional neural network layers; based on the calculation parameters, configuring a data topological relationship between a plurality of processing element clusters in a processing element cluster set of a processor as a target data topological relationship, to form a reconstructed processing element cluster set; and inputting input-feature-map data of the convolutional neural network layers and convolution kernel data of the convolutional neural network layers into the reconstructed processing element cluster set for convolution operation based on the calculation parameters to obtain output feature map data.

### CROSS-REFERENCE TO RELATED APPLICATION

This application claims priority to Chinese Patent Application No. 202311437274.2, filed on Oct. 31, 2023, the entire content of which is incorporated herein by reference.

### TECHNICAL FIELD

The present disclosure generally relates to the field of neural network technology and artificial intelligence technology and, more particularly, to a neural network computing method, a processor, and a device thereof.

### BACKGROUND

In a convolutional neural network (CNN), such as a dynamic convolution neural network (DCNN), as the number of network layers increases, the computational dimensions of the network layers will change greatly. For example, a sharp increase in the size of the input channels and the output channels may occur, while the size of the feature image continues to shrink. Most neural network processor architectures use a relatively fixed computational cluster, and the computational efficiency of using the relatively fixed computational cluster to calculate convolutional neural networks with constantly changing computational dimensions of the network layer is not high.

### SUMMARY

One embodiment of the present disclosure provides a neural network calculation method. The method includes determining calculation parameters of convolutional neural network layers; based on the calculation parameters, configuring a data topological relationship between a plurality of processing element clusters in a processing element cluster set of a processor as a target data topological relationship, to form a reconstructed processing element cluster set; and inputting input-feature-map data of the convolutional neural network layers and convolution kernel data of the convolutional neural network layers into the reconstructed processing element cluster set for convolution operation based on the calculation parameters to obtain output feature map data.

Another embodiment of the present disclosure provides a processor. The processor includes a processing element cluster set and a controller. The processing element cluster set includes a plurality of processing element clusters, and a data topological relationship between the processing element clusters is re-constructible; and the controller is configured to: determine calculation parameters of convolutional neural network layers; based on the calculation parameters, configure the data topological relationship between the plurality of processing element clusters in the processing element cluster set as a target data topological relationship, to form a reconstructed processing element cluster set; and input input-feature-map data of the convolutional neural network layers and convolution kernel data of the convolutional neural network layers into the reconstructed processing element cluster set for convolution operation based on the calculation parameters to obtain output feature map data.

Another embodiment of the present disclosure provides a computer device. The computer device includes one or more processors and a memory containing a computer program that, when being executed, causes the one or more processors to perform: determining calculation parameters of convolutional neural network layers; based on the calculation parameters, configuring a data topological relationship between a plurality of processing element clusters in a processing element cluster set of a processor as a target data topological relationship, to form a reconstructed processing element cluster set; and inputting input-feature-map data of the convolutional neural network layers and convolution kernel data of the convolutional neural network layers into the reconstructed processing element cluster set for convolution operation based on the calculation parameters to obtain output feature map data.

### BRIEF DESCRIPTION OF THE DRAWINGS

FIG. 1 is a flowchart of a neural network computing method consistent with various embodiments of the present disclosure.

FIG. 2 is a schematic architectural diagram of a processing element cluster consistent with various embodiments of the present disclosure.

FIG. 3 is a schematic diagram of a processing element cluster performing convolution computing consistent with various embodiments of the present disclosure.

FIG. 4 is another schematic diagram of a processing element cluster performing convolution computing consistent with various embodiments of the present disclosure.

FIG. 5 is a schematic diagram of convolution neural network computing consistent with various embodiments of the present disclosure.

FIG. 6 is a schematic diagram of an architecture of a processing element cluster set consistent with various embodiments of the present disclosure.

FIG. 7 is a schematic diagram of reconstruction of a processing element cluster set consistent with various embodiments of the present disclosure.

FIG. 8 is a schematic diagram of data correlation between processing element clusters consistent with various embodiments of the present disclosure.

FIG. 9 is a schematic diagram of a neural network computing method consistent with various embodiments of the present disclosure.

FIG. 10 is a schematic diagram of reconstruction of a processing element cluster set consistent with various embodiments of the present disclosure.

FIG. 11 is a schematic structural diagram of a processor consistent with various embodiments of the present disclosure.

FIG. 12 is a hardware schematic diagram of a computer device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Those skilled in the art will envision other modifications within the scope and spirit of the present disclosure.

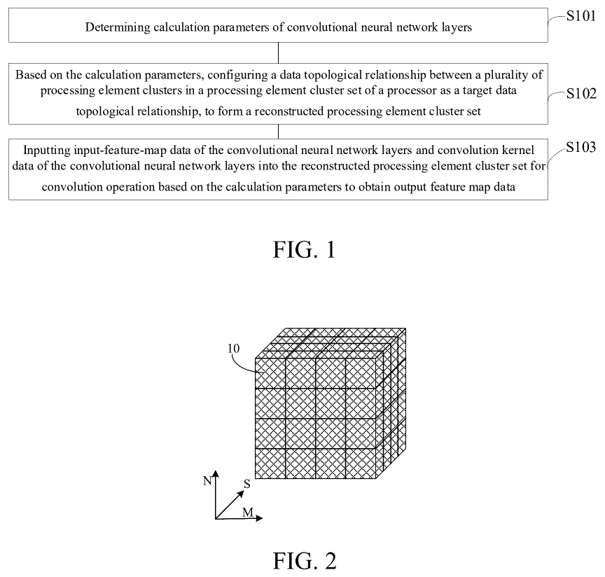

The present disclosure provides a neural network computing method. The neural network computing method may be executed by a process of a computer device. The computer device may be a server, a laptop, a tablet, a desktop computer, a smart TV, a set-top box, a mobile device (such as a mobile phone, a portable video player, a personal digital assistant, a dedicated messaging device, a portable gaming device) or other devices with data processing capabilities. In one embodiment, as shown in FIG. 1 which is a flowchart of a neural network computing method consistent with various embodiments of the present disclosure, the method includes S101 to S103.

At S101, calculation parameters of convolutional neural network layers are determined.

The convolutional neural network may include a plurality of convolutional neural network layers. Each convolutional neural network layer of the plurality of convolutional neural network layers may correspond to different calculation parameters because it performs different convolution calculations. The calculation parameters may include at least one of input-feature-map data, convolution kernel data, or output feature map data corresponding to the convolutional neural network layer.

In some embodiments, feature information of one convolutional neural network layer may be obtained, and the calculation parameters of the convolutional neural network layer may be determined based on the feature information. The feature information of the convolutional neural network layer may be specific structural information of the convolutional neural network layer or depth information of the convolutional neural network layer in the convolutional neural network.

At S102, based on the calculation parameters, a data topological relationship between a plurality of processing element clusters in a processing element cluster set of a processor is configured as a target data topological relationship, to form a reconstructed processing element cluster set.

One processing element cluster (Micro PE-Cluster) may include a plurality of processing elements (PEs). Generally, one PE may include at least one multiplication and addition unit, a small number of registers, and a small amount of control logic. The entire architecture may adopt data flow control, that is, all processing elements may form a processing chain relationship, and data may be directly transmitted between processing elements. One processing element may include one or more multipliers and adders, which are able to realize highly parallel computing. The data topological relationship between the processing element clusters may represent the corresponding relationship between each processing element cluster and the data to be input and/or the data to be output when performing convolution operations. The data to be input here may include input-feature-map data and/or convolution kernel data, and the data to be output may include output feature map data. It can be understood that to facilitate centralized calculations in the processing element cluster, the input-feature-map data may be divided into multiple input-feature-map data blocks, the convolution kernel data may be divided into multiple convolution kernel data blocks, and the output feature map data may be divided into multiple output feature map data blocks. In the target data topological relationship, each processing element cluster may have a certain input-feature-map data block, a certain convolution kernel data block, or a certain output feature map data block.

In some embodiments, different processing element clusters may have the same input-feature-map data blocks or convolution kernel data blocks, or may have different input-feature-map data blocks and convolution kernel data blocks. During implementation, the data topological relationship between the plurality of processing element clusters may be configured as the target data topological relationship by configuring the input-feature-map data blocks and convolution kernel data blocks corresponding to each processing element cluster.

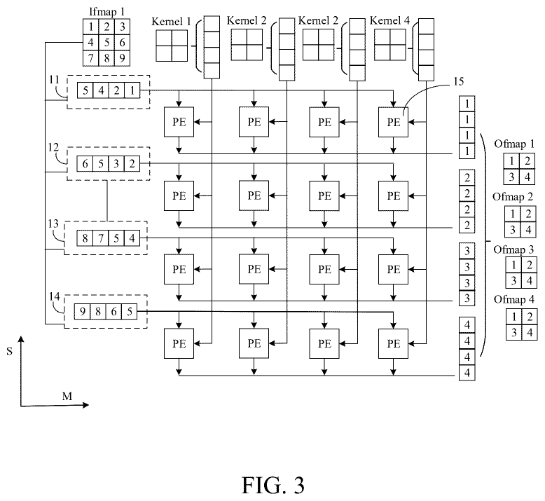

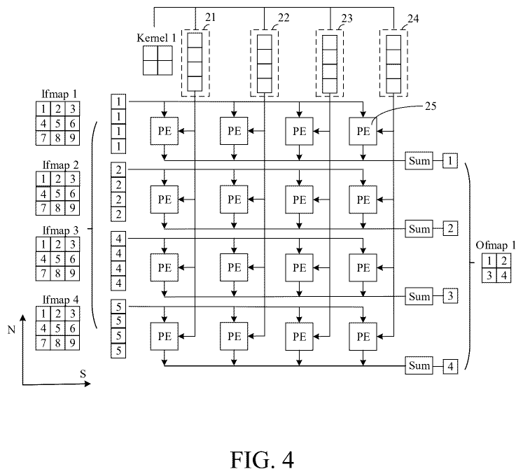

In some embodiments, one processing element cluster may be of any suitable size, which is not limited here. For example, the processing element cluster may be of 3×3×3 size or 4×4×4 size. FIG. 2 is a schematic diagram of a processing element cluster of 4×4×4 size. As shown in FIG. 2, the processing element cluster may include 64 processing elements 10, and N, S, and M correspond to different transmission directions of data between processing elements 10. The processing element cluster may perform convolution calculations on different data on the S×M plane and the N×S plane. In some embodiments, the processing element cluster may be of 4×4×4 size. The processing element cluster may complete a convolution calculation with an output feature map size of 4, a convolution kernel number of 4, and an input channel number of 4 in a single cycle, or a 4×4 matrix multiplication operation may be completed in a single cycle. As shown in FIG. 3 which is a schematic diagram of the processing element cluster performing convolution calculations on data corresponding to the S×M plane, the processing element cluster may include multiple processing elements (PE) 15. In FIG. 3, a 2×2 convolution kernel may be used to calculate the input feature map Ifmap1 of size 3×3=9. Based on the input feature map Ifmap1, image rows 11, 12, 13 and 14 may be determined. Convolution kernels Kernel1, Kernel2, Kernel3 and Kernel4 may be used to perform convolution calculations on the four image rows to obtain output feature maps Ofmap1, Ofmap2, Ofmap3 and Ofmap4 with a size of 4×1. As shown in FIG. 4 which is a schematic diagram of the processing element cluster performing convolution calculations on data corresponding to the N×S surface, the processing element cluster may include multiple processing elements (PEs) 25. In FIG. 4, channels 21, 22, 23 and 24 of the convolution kernel Kernel1 may be used to perform convolution calculations on input feature maps Ifmap1, Ifmap2, Ifmap3 and Ifmap4 with a size of 3×3=9, respectively, to obtain multiple summation results Sum. Based on the multiple Sums, an output feature map Ofmap1 with a size of 4 may be obtained.

In some embodiments, the processor may be in any suitable form and is not limited herein. For example, the processor may be one of a CPU (Central Processing element), a GPU (Graphics Processing element), or an FPGA (Field Programmable Gate Array).

At S103, according to the calculation parameters, the input-feature-map data of one convolutional neural network layer and the convolution kernel data of the convolutional neural network layer are input into the reconstructed processing element cluster set for convolution operation to obtain output feature map data.

In some embodiments, at least one input-feature-map data block and at least one convolution kernel data block of the convolutional neural network layer may be input into the reconstructed processing element cluster set for convolution operation according to the calculation parameters to obtain at least one output feature map data block.

In the present disclosure, the calculation parameters of the convolutional neural network layer may be determined. Based on the calculation parameters, the data topological relationship between the multiple processing element clusters in the processing element cluster set of the processor may be configured as the target data topological relationship to form a reconstructed processing element cluster set. According to the calculation parameters, the input-feature-map data of the convolutional neural network layer and the convolution kernel data of the convolutional neural network layer may be input into the reconstructed processing element cluster set for convolution operation to obtain the output feature map data. In this way, reconstructing the processing element cluster set based on the calculation parameters of the convolutional neural network layer may improve the adaptability between each convolutional neural network layer and the processing element cluster set, thereby improving the computing efficiency of the processor.

In some embodiments, the calculation parameters may include a block parameter, and the output feature map data may include at least one output feature map data block. S103 where the input-feature-map data of the convolutional neural network layer and the convolution kernel data of the convolutional neural network layer are input to the reconstructed processing element cluster set for convolution operation to obtain the output feature map data according to the calculation parameters may include S111 to S112.

At S111, according to the block parameter, the input-feature-map data of the convolutional neural network layer and the convolution kernel data of the convolutional neural network layer are cached in blocks into a data cache space of a cache module of the processor.

The block parameter may be used to determine the size of the input-feature-map data, convolution kernel data, or output feature map data cached to the data cache space. It can be understood that, after the input-feature-map data and the convolution kernel data are divided into blocks, one processing element cluster may be able to complete the convolution calculation of one input-feature-map data block and one convolution kernel data block in a single cycle, and the processing element cluster set may be able to complete the convolution calculation of at least one input-feature-map data block and at least one convolution kernel data block in a single cycle.

In some embodiments, the blocking parameter may include at least one of an input dimension parameter, an output dimension parameter, or a convolution kernel dimension parameter, of the convolutional neural network layer.

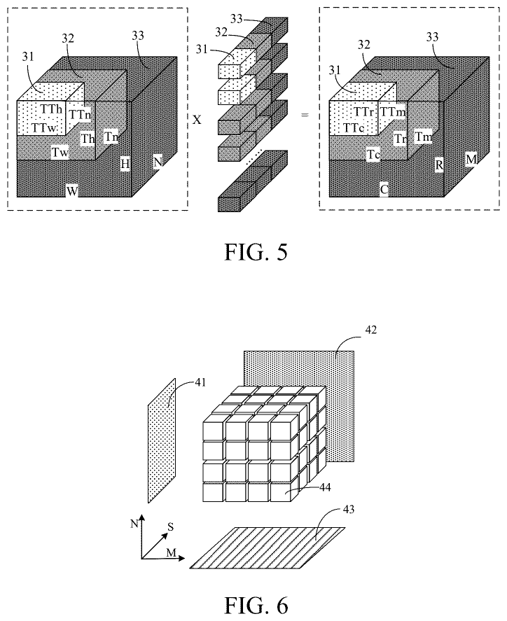

In some embodiments, the cache module may include an on-chip cache and an off-chip cache. The data cache space may be the storage space in the on-chip cache. To explain the on-chip cache and off-chip cache in detail, in the convolution calculation for the input-feature-map data which is W×H×N to obtain the output feature map data of C×R×M after convolution, the neural network calculation in FIG. 5 will be used as an example. As shown in FIG. 5, W×H×N represents the size of the input-feature-map data, Tw×Th×Tn represents the size of the input-feature-map data stored in the on-chip cache, and TTw×TTh×TTn represents the size of the input-feature-map data that the processing element cluster set is able to calculate in a single cycle. C×R×M represents the output feature map data, Tc×Tr×Tm represents the size of the output feature map data stored in the on-chip cache, and TTc×TTr×TTm represents the size of the output feature map data that the processing element cluster set is able to calculate in a single cycle. Area 31 represents the data that the processing element cluster set is able to calculate in a single cycle, area 32 represents the data stored in the on-chip cache, and area 33 represents the data stored in the off-chip cache. During the calculation process, the processing element cluster set may directly obtain the data in area 31 from the on-chip cache each time, complete the calculation of area 31, and then continue to access the on-chip cache to obtain the data to be processed next time, and perform the next processing until the calculation of all areas 32 is completed. After the calculation of the entire area 32 is completed, the area 33 may be traversed until all convolution calculations are completed. The data in the off-chip cache may first be cached in the on-chip cache, and then read and used by the processing element cluster set.

At S112, for each cached input-feature-map data block and each cached convolution kernel data block, the input-feature-map data block and the convolution kernel data block are input into the reconstructed processing element cluster set according to the target data topological relationship for convolution operation, and the output feature map data block is obtained and cached into the data cache space.

In some embodiments, 16 input-feature-map data blocks and 4 convolution kernel data blocks may be cached in the data cache space, and there may be 4 processing element clusters in the processing element cluster set. According to the target data topological relationship, one input-feature-map data block may be input into 4 processing element clusters at a time, and 4 convolution kernel data blocks may be respectively input into 4 different processing element clusters for convolution operation. The output feature map data block may be obtained and cached into the data cache space.

In some other embodiments, 16 input-feature-map data blocks and 4 convolution kernel data blocks may be cached in the data cache space, and there may be 4 processing element clusters in the processing element cluster set. According to the target data topological relationship, the 4 input-feature-map data blocks may be input into 4 different processing element clusters at a time, and 1 convolution kernel data block may be input into 4 identical processing element clusters for convolution operation. The output feature map data block may be obtained and cached in the data cache space.

In the present disclosure, the input-feature-map data blocks and the convolution kernel data blocks may be input into the reconstructed processing element cluster set for convolution operation according to the target data topological relationship, and the output feature map data blocks may be obtained and cached in the data cache space. In this way, the convolution operation based on the block-based input-feature-map data and convolution kernel data may be beneficial to a more refined allocation of the computing resources of the processor, thereby improving the computing efficiency of the processor.

In some embodiments, the cache module may include the data cache space and a calculation cache space. The data cache space may include an input cache area, a weight cache area, and an output cache area. The calculation cache space may include an input cache block, a weight cache block, and an output cache block respectively possessed by each processing element cluster in the processing element cluster set. At S102, based on the calculation parameters, configuring the data topological relationship between multiple processing element clusters in the processing element cluster set of the processor as the target data topological relationship to form the reconstructed processing element cluster set, may include:
S121, based on the block parameter, configuring the mapping relationship between each cache block in the output cache area in the data cache space and the output cache block of each processing element cluster in the calculation cache space to a first mapping relationship, the mapping relationship between each cache block in the input cache area and the input cache block of each processing element cluster to a second mapping relationship, and the mapping relationship between each cache block in the weight cache area and the weight cache block of each processing element cluster to a third mapping relationship, such that the data topological relationship between multiple processing element clusters in the processing element cluster set of the processor is configured to the target data topological relationship, thereby forming the reconstructed processing element cluster set.

The cache module may include an on-chip cache and an off-chip cache, and the data cache space and the calculation cache space may be storage spaces in the on-chip cache. The input cache area may be used to store input-feature-map data blocks, the weight cache area may be used to store convolution kernel data blocks, and the output cache area may be used to store output feature map data blocks. It can be understood that, by configuring the mapping relationship between each input cache block and the processing element clusters, the processing element clusters may read data from or write data to any cache block in the data cache space, which may be flexibly configured according to the block parameters of the convolutional neural network layer.

In some embodiments, the calculation cache space may include a target input cache area, a target weight cache area, and a target output cache area. The processing element cluster set may have a target input cache area, a target weight cache area, and a target output cache area, correspondingly. The target input cache area may include an input cache block corresponding to each processing element cluster, the target weight cache area may include a weight cache block corresponding to each processing element cluster, and the target output cache area may include an output cache block corresponding to each processing element cluster.

In some embodiments, taking the second mapping relationship as an example, when the mapping relationship between each cache block in the input cache area and the input cache block of each processing element cluster is the second mapping relationship, when the multiple processing element clusters in the processing element cluster set perform convolution operations, the processing element clusters may obtain the input-feature-map data block from the corresponding input cache block, and the input-feature-map data block in each input cache block may be read from a specific cache block in the input cache area based on the second mapping relationship. For example, when the mapping relationship between each cache block in the input cache area and the input cache block of each processing element cluster is the second mapping relationship, the input cache block of each processing element cluster may read data from the first cache block in the input cache area. When the mapping relationship between each cache block in the input cache area and the input cache block of each processing element cluster is the fourth mapping relationship, the input cache block of each processing element cluster may read data from the second cache block in the input cache area.

In some embodiments, at S112, according to the target data topological relationship, inputting the input-feature-map data blocks and the convolution kernel data blocks into the reconstructed processing element cluster set for convolution operation, to obtain and cache the output feature map data blocks into the data cache space, may include:
S131, according to the second mapping relationship and the third mapping relationship, reading the input-feature-map data blocks in the input cache area and the convolution kernel data blocks in the weight cache area respectively into the reconstructed processing element cluster set for convolution operation, to obtain and cache the output feature map data blocks into the output cache area in the data cache space according to the first mapping relationship.

In some embodiments, for multiple processing element clusters, the multiple processing element clusters may read the input-feature-map data blocks in the same input cache area or the convolution kernel data blocks in the same weight cache area to the reconstructed processing element cluster set for convolution operation according to the respective corresponding second mapping relationship and the third mapping relationship, or may read the input-feature-map data blocks in different input cache areas and the convolution kernel data blocks in different weight cache areas to the reconstructed processing element cluster set for convolution operation.

In the present disclosure, by configuring the mapping relationship between each cache block in the output cache area in the data cache space and the output cache blocks of each processing element cluster in the calculation cache space to the first mapping relationship, configuring the mapping relationship between each cache block in the input cache area and the input cache blocks of each processing element cluster to the second mapping relationship, and configuring the mapping relationship between each cache block in the weight cache area and the weight cache blocks of each processing element cluster to the third mapping relationship, each processing element cluster in the processing element cluster set and each cache block in the data cache space may adapt to each other, which is beneficial to improve the utilization rate of computing resources in the processor.

In some embodiments, the block parameter may include the number of input channels in the input cache area, the number of convolution kernels in the weight cache area, and the size of a single-layer output data block in the output cache area. At S121, based on the block parameter, configuring the mapping relationship between each cache block in the output cache area in the data cache space and the output cache blocks of each processing element cluster in the calculation cache space to the first mapping relationship, configuring the mapping relationship between each cache block in the input cache area and the input cache blocks of each processing element cluster to the second mapping relationship, and configuring the mapping relationship between each cache block in the weight cache area and the weight cache blocks of each processing element cluster to the third mapping relationship, may include S141 to S144.

At S141, based on the number of input channels in the input cache area, the number of convolution kernels in the weight cache area, and the size of the single-layer output data block in the output cache area, first correlation between the output cache blocks of the corresponding processing element clusters, second correlation between the input cache blocks of the processing element clusters, and third correlation between the weight cache blocks of the processing element clusters may be determined respectively.

The processing element clusters may be distributed in a regular shape or an irregular shape. To more clearly illustrate the various correlations, taking FIG. 6 as an example, there are 4096 processing elements in FIG. 6, and the processing element cluster set is distributed in a regular shape of 4×4×4 in the three directions of M, N, and S with the processing element clusters 44. Each processing element cluster 44 is arranged as 4×4×4 processing elements. One input-feature-map data block in the input-feature-map data 41 is loaded along the M direction, and the same input-feature-map data block is simultaneously broadcast to the input cache blocks of the four processing element clusters 44 in the M direction. The input-feature-map data blocks of all processing element clusters 44 in the S×N direction are unrelated. The second correlation between the input cache blocks of the processing element clusters 44 under this architecture is recorded as 4. One convolution kernel data block in the convolution kernel data 42 is loaded along the reverse direction of S, and the same convolution kernel data block is simultaneously broadcast to the weight cache blocks of the four processing element clusters 44 in the S direction. The convolution kernel data blocks of all processing element clusters in the M×N direction are unrelated. The third correlation between the weight cache blocks of the processing element clusters 44 under this architecture is recorded as 4. One output feature map data block in the output feature map data 43 is correlated along the reverse direction of N, and the calculation results of the four processing element clusters 44 are summed along the reverse direction of N. The output feature map data blocks of all processing element clusters 44 in the S×M direction are unrelated. The first correlation between the output cache blocks of the processing element clusters 44 under this architecture is recorded as 4.

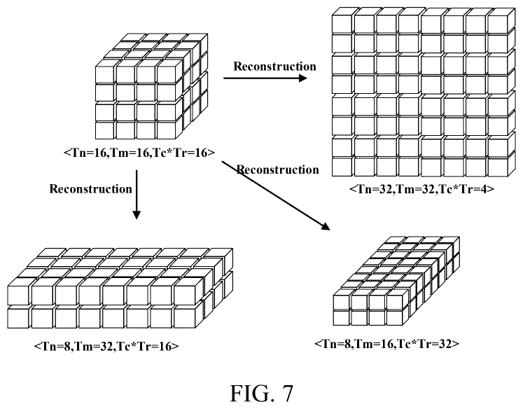

In some embodiments, the first correlation between the output cache blocks of each corresponding processing element cluster, the second correlation between the input cache blocks of each processing element cluster, and the third correlation between the weight cache blocks of each processing element cluster, may be determined based on the number of input channels in the input cache area, the number of convolution kernels in the weight cache area, the size of a single-layer output data block in the output cache area, and the size of the processing element cluster. For example, when the processing element cluster is 4×4×4 in size and the number of input channels in the input cache area is 3, the first correlation between the output cache blocks of each corresponding processing element cluster may be determined to be 1. In some embodiments, as shown in FIG. 7, when the processing element cluster is 4×4×4 in size, when the number of input channels in the input cache area Tn is 8, the number of convolution kernels in the weight cache area Tm is 32, and the size of a single-layer output data block in the output cache area Tc×Tr is 16, reconstruction may be performed to determine that the first correlation between the output cache blocks of the corresponding processing element clusters is 2, the second correlation between the input cache blocks of the processing element clusters is 8, and the third correlation between the weight cache blocks of the processing element clusters is 4. When the number of input channels in the input cache area Tn is 8, the number of convolution kernels in the weight cache area Tm is 16, and the size of a single-layer output data block in the output cache area Tc×Tr is 32, reconstruction may be performed to determine that the first correlation between the output cache blocks of the corresponding processing element clusters is 2, the second correlation between the input cache blocks of the processing element clusters is 4, and the third correlation between the weight cache blocks of the processing element clusters is 8. When the number of input channels in the input cache area Tn is 32, the number of convolution kernels in the weight cache area Tm is 32, and the size of the single-layer output data block in the output cache area Tc×Tr is 4, reconstruction may be performed to determine that the first correlation between the output cache blocks of the corresponding processing element clusters is 8, the second correlation between the input cache blocks of the processing element clusters is 8, and the third correlation between the weight cache blocks of the processing element clusters is 1.

In some embodiments, the number of input channels in the input cache may be the number of input channels of the input-feature-map data stored in the input cache. For example, the input-feature-map data size in the input cache corresponding to the convolutional neural network layer may be 224×224, and the number of input channels may be 3. The single-layer output data block size in the output cache may be the number of output channels of the output feature map data stored in the output cache.

In some embodiments, when the processing element cluster is 4×4×4 in size and the number of input channels in the input cache is 3, it may be determined that the first correlation between the output cache blocks of the corresponding processing element clusters is 1.

At S142, based on the first correlation, the output cache block of each of the processing element clusters is mapped to at least one target cache block in the output cache area to obtain the first mapping relationship.

In some embodiments, when the processing element cluster is 4×4×4 in size and the first correlation is 1, the output cache blocks of different processing element clusters may be mapped to different target cache blocks in the output cache area to obtain the first mapping relationship.

In some other embodiments, when the processing element cluster is 4×4×4 in size and the first correlation is 4, the output cache blocks of every 4 processing element clusters may be mapped to one same target cache block in the output cache area to obtain the first mapping relationship.

At S143, based on the second correlation, the input cache block of each of the processing element clusters is mapped to at least one target cache block in the input cache area to obtain the second mapping relationship.

In some embodiments, when the processing element cluster is 4×4×4 in size and the second correlation is 1, the input cache blocks of different processing element clusters may be mapped to different target cache blocks in the input cache area to obtain the second mapping relationship.

In some other embodiments, when the processing element cluster is 4×4×4 in size and the second correlation is 4, the input cache blocks of every 4 processing element clusters may be mapped to one same target cache block in the input cache area to obtain the second mapping relationship.

At S144, based on the third correlation, the weight cache block of each of the processing element clusters is mapped to at least one target cache block in the weight cache area to obtain the third mapping relationship.

In some embodiments, when the processing element cluster is 4×4×4 in size and the third correlation is 1, the weight cache blocks of different processing element clusters may be mapped to different target cache blocks in the weight cache area to obtain the third mapping relationship.

In some embodiments, when the processing element cluster is 4×4×4 in size, and the third correlation is 4, the weight cache blocks of every 4 processing element clusters may be mapped to one same target cache block in the weight cache area to obtain the third mapping relationship.

In the present disclosure, based on the number of input channels in the input cache area, the number of convolution kernels in the weight cache area, and the size of the single-layer output data block in the output cache area, the first correlation between the output cache blocks of the corresponding processing element clusters, the second correlation between the input cache blocks of the processing element clusters, and the third correlation between the weight cache blocks of the processing element clusters may be respectively determined. When the processing element cluster set has a limited number of processing element clusters, the processing element clusters may be managed in a refined manner by changing the correlation of data between each processing element cluster, thereby improving the computing resource utilization rate when the processing element cluster set performs convolution operations.

In some embodiments, at S101, determining the calculation parameters of one convolution neural network layer may include S151 to S152.

At S151, the input dimension parameter, the output dimension parameter and the convolution kernel dimension parameter of the convolution neural network layer are obtained.

In some embodiments, the input dimension parameter may include the size of the input-feature-map data, the output dimension parameter may include the size of the output feature map data, and the convolution kernel dimension parameter may include the size and number of the convolution kernels.

At S152, based on the input dimension parameter, the output dimension parameter, the convolution kernel dimension parameter and the capacity of the data cache space, the calculation parameters of the convolution neural network layer are determined.

In some embodiments, the capacity of the data cache space may include the capacity of the input cache area, the capacity of the weight cache area, and the capacity of the output cache area. In some embodiments, the calculation parameters of the convolution neural network layer may be determined based on the input dimension parameter, the output dimension parameter, the convolution kernel dimension parameter and the capacity of the input cache area, the capacity of the weight cache area, and the capacity of the output cache area.

In the present disclosure, the calculation parameters of the convolution neural network layer may be determined based on the input dimension parameter, the output dimension parameter, the convolution kernel dimension parameter and the capacity of the data cache space. The data cache space may be fully taken into account when performing the convolution neural network layer calculation, thereby making the calculation parameters of the convolution neural network layer and the capacity of the cache space more adapted, which is conducive to improving the utilization efficiency of the data cache space.

In some embodiments, at S152, based on the input dimension parameter, the output dimension parameter, the convolution kernel dimension parameter and the capacity of the data cache space, determining the calculation parameters of the convolution neural network layer, may include:
S161: based on the input dimension parameter, the output dimension parameter, the convolution kernel dimension parameter and the capacity of the data cache space, determining the data reuse mode and the calculation parameters corresponding to the convolutional neural network layer.

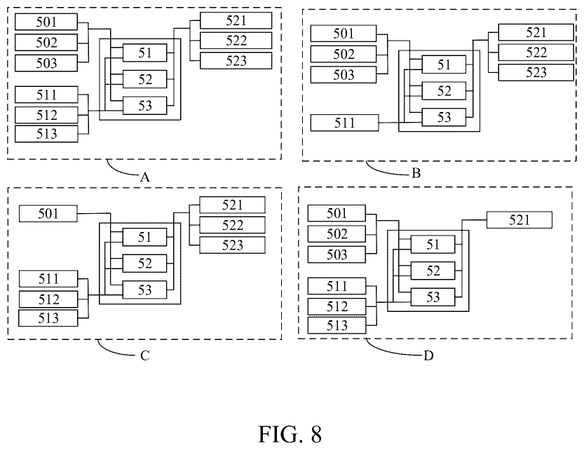

In some embodiments, the data reuse mode may include an input data reuse mode, a weight data reuse mode, or an output data reuse mode. The processing element clusters may be able to realize data interconnection by configuring different interconnection mechanisms for the same type of data. Under different data reuse modes, the processing element clusters may have different repeated access times to different types of data. As shown in FIG. 8, in mode A without data reuse, the processing element cluster 51, the processing element cluster 52 and the processing element cluster 53 may all access the input data 501, the input data 502, the input data 503, the weight data 511, the weight data 512, the weight data 512, and may all output the output data 521, the output data 522, and the output data 523.

In an input data reuse mode B, the processing element cluster 51, the processing element cluster 52 and the processing element cluster 53 may all access the input data 501, the weight data 511, the weight data 512, the weight data 512, and output the output data 521, the output data 522, and the output data 523.

In a weight data multiplexing mode C, the processing element cluster 51, the processing element cluster 52 and the processing element cluster 53 may all access the input data 501, the input data 502, the input data 503, and the weight data 511; and may all output the output data 521, the output data 522, and the output data 523.

In an output data multiplexing mode D, the processing element cluster 51, the processing element cluster 52 and the processing element cluster 53 may all access the input data 501, the input data 502, the input data 503, the weight data 511, the weight data 512, the weight data 512, and may output the output data 521.

In some embodiments, different data reuse modes may correspond to different data traversal directions when performing neural network calculations using a processing element cluster set. As shown in FIG. 5, for example, in the input data reuse mode, traverse may be performed along the M direction first; in the weight data reuse mode, traverse may be performed along the R×C or W×H direction first; and, in the output data reuse mode, traverse may be performed along the N direction first.

In some embodiments, at S111, caching the input-feature-map data of the convolutional neural network layer and the convolution kernel data of the convolutional neural network layer into the data cache space of the cache module of the processor in blocks according to the block parameters may include:
S171, caching the input-feature-map data of the convolutional neural network layer and the convolution kernel data of the convolutional neural network layer in blocks into the data cache space according to the data reuse mode and the calculation parameters.

In the present disclosure, by caching the input-feature-map data of the convolutional neural network layer and the convolution kernel data of the convolutional neural network layer in blocks into the data cache space according to the data reuse mode and the calculation parameters, the computational efficiency of the neural network calculation in the subsequent process may be improved.

In some embodiments, at S161, based on the input dimension parameter, the output dimension parameter, the convolution kernel dimension parameter and the capacity of the data cache space, determining the data reuse mode and the calculation parameters corresponding to the convolution neural network layer may include S171 to S173.

At S171, for each candidate data reuse mode among at least one candidate data reuse mode, based on the input dimension parameter, the output dimension parameter, the convolution kernel dimension parameter and the capacity of the data cache space, the minimum processing energy consumption corresponding to the convolution neural network layer under the candidate data reuse mode, and the candidate calculation parameters corresponding to the minimum processing energy consumption, are determined.

It can be understood that since the access energy of the off-chip cache is approximately more than 200 times the access energy of the on-chip cache, the impact of the number of memory accesses of the off-chip cache on the minimum processing energy consumption is focused on. In implementation, the following formula may be used to calculate the minimum processing energy consumption energy:

$$Energy = {MA}_{DRAM} \times {E}_{DRAM} + {MA}_{buffer} \times {E}_{buffer} \approx {MA}_{DRAM} \times {E}_{DRAM} = ( TI \times {α}_{i} + TO \times {α}_{o} + TW \times {α}_{w} ) \times {E}_{DRAM} \qquad ( 1 )$$

where MA_{DRAM} indicates the number of accesses to the off-chip cache, E_{DRAM} indicates the energy consumption for each access to the off-chip cache, MA_{buffer} indicates the number of accesses to the on-chip cache, E_{buffer} indicates the energy consumption for each access to the on-chip cache, TI, TO, and TW correspond to the total number of inputs, outputs, and weights of the current convolutional neural network layer, respectively; and αᵢ, αₒ, and α_{w} correspond to the number of repeated accesses to the input, output, and weight during the calculation process, respectively.

It can be seen from formula (1) that since each convolutional neural network layer has a certain number of inputs, outputs and weights when performing convolution operations, it may be necessary to adjust αᵢ, αₒ, and α_{w} to determine the minimum processing energy consumption. In some embodiments, the candidate data reuse mode may include an input data reuse mode, a weight data reuse mode, or an output data reuse mode. In the input data reuse mode, αᵢ, αₒ, and α_{w} may be determined based on the following formulas (2), (3), and (4):

$${α}_{i} = 1 \qquad ( 2 )$$

$${α}_{o} = \{ \begin{matrix}0 , & M \times {T}_{r} \times {T}_{c} \leq {B}_{o} \\ 2 ( ⌈ \frac{N}{{T}_{n}} ⌉ - 1 ) , & M \times {T}_{r} \times {T}_{c} > {B}_{o}\end{matrix} \qquad ( 3 )$$

$${α}_{w} = \{ \begin{matrix}1 , & TW \leq {B}_{w} \\ ⌈ \frac{W}{{T}_{W}} ⌉ \times ⌈ \frac{H}{{T}_{h}} ⌉ , & TW > {B}_{w}\end{matrix} . \qquad ( 4 )$$

In the weight data reuse mode, αᵢ, αₒ, and α_{w} may be determined based on the following formulas (5), (6), and (7):

$${α}_{i} = \{ \begin{matrix}1 , & TI \leq {B}_{i} \\ ⌈ \frac{M}{{T}_{m}} ⌉ & TI > {B}_{i}\end{matrix} \qquad ( 5 )$$

$${α}_{o} = \{ \begin{matrix}0 , & M \times {T}_{r} \times {T}_{c} \leq {B}_{o} \\ 2 ( ⌈ \frac{N}{{T}_{n}} ⌉ - 1 ) , & M \times {T}_{r} \times {T}_{c} > {B}_{o}\end{matrix} \qquad ( 6 )$$

$${α}_{w} = 1 . \qquad ( 7 )$$

In the output data reuse mode, αᵢ, αₒ, and α_{w} may be determined based on the following formulas (8), (9), and (10):

$${α}_{i} = \{ \begin{matrix}1 , & N \times {T}_{h} \times {T}_{w} \leq {B}_{i} \\ ⌈ \frac{M}{{T}_{m}} ⌉ , & N \times {T}_{h} \times {T}_{w} > {B}_{i}\end{matrix} \qquad ( 8 )$$

$${α}_{o} = 0 , \qquad ( 9 )$$

$${α}_{w} = \{ \begin{matrix}1 , & TW \leq {B}_{w} \\ ⌈ \frac{R}{{T}_{r}} ⌉ \times ⌈ \frac{C}{{T}_{c}} ⌉ , & TW > {B}_{w}\end{matrix} . \qquad ( 10 )$$

In formulas (2) to (10), βᵢ, βₒ, β_{w} correspond to the capacities of the input cache, the output cache, and the weight cache, respectively, as shown in FIG. 5. Tᵣ, T_{c}, Tₘ are parameters representing the output feature map data stored in the on-chip cache, Tₙ is a parameter representing the input-feature-map data stored in the on-chip cache, M, R, and C are output dimension parameters, and N, H, and W are output dimension parameters.

In some embodiments, based on the above formulas (1)-(10), the minimum processing energy consumption corresponding to each candidate data reuse mode and the candidate calculation parameters corresponding to the minimum processing energy consumption may be determined.

At S172, based on the minimum processing energy consumption corresponding to each of the candidate data reuse modes, the data reuse mode corresponding to the convolutional neural network layer is determined.

In some embodiments, after determining the minimum processing energy consumption corresponding to each candidate data reuse mode, a target minimum processing energy consumption may be selected from the multiple minimum processing energy consumptions, and the candidate data reuse mode corresponding to the target minimum processing energy consumption may be determined as the data reuse mode corresponding to the convolutional neural network layer.

At S173, the candidate calculation parameters corresponding to the data reuse mode are determined as the calculation parameters corresponding to the convolutional neural network layer.

In some embodiments, the candidate calculation parameters may include Tᵣ, T_{c}, Tₘ and Tₙ, and Tᵣ, T_{c}, Tₘ and Tₙ corresponding to the data reuse mode may be determined as the calculation parameters corresponding to the convolutional neural network layer.

In the present disclosure, by determining the data reuse mode corresponding to the convolutional neural network layer based on the minimum processing energy consumption corresponding to each candidate data reuse mode, one adaptive data reuse mode and calculation parameters may be determined for each convolutional neural network layer, which may improve the data reuse rate of the convolutional neural network layer when performing convolution calculations, thereby speeding up the calculation speed of the convolutional neural network layer performing convolution calculations.

The following describes the application of the neural network calculation method provided by the present disclosure in actual scenarios, by taking the scenario of deep convolutional neural network calculation as an example.

For deep convolutional neural networks, as the network level increases, the calculation dimension size of the network layers may change greatly, which may be generally manifested as a sharp increase in the size of the input channels and the output channels, while the feature image size is shrinking. Taking the VGG (Visual Geometry Group) model as an example, the feature image size of the first two convolutional layers of the VGG model may be (224×224, 224×224), the number of input channels may be (3, 64), and the number of output channels may be (64, 64). The feature image size of the last two convolutional layers may be (14×14, 7×7), the number of input channels may be (512, 512), and the number of output channels may be (512, 512). Further, this feature may become more obvious as the network level deepens. In related technologies, neural network processing architectures mostly use relatively fixed computing arrays, which are manifested in the following two aspects. First, fixed data streams are used for different computing layers, and the overall data reuse rate is not high. Second, there are certain requirements for the feature image size of the convolution layer and the number of input and output channels, especially for the size of the input channels. The input data format is generally NC′HWC32 (8-bit) or NC′HWC16 (16-bit). Therefore, the input channels are also required to be an integer multiple of 16 or 32. The above characteristics of convolutional neural networks lead to the problem of low processing unit utilization when some convolutional layers are deployed on a fixed computing architecture. Taking the first layer of VGG (feature map size is 224×224×3) as an example, the processing unit utilization of most neural network processors when processing this layer is only 3/16 or 3/32, which leads to a decrease in computing efficiency.

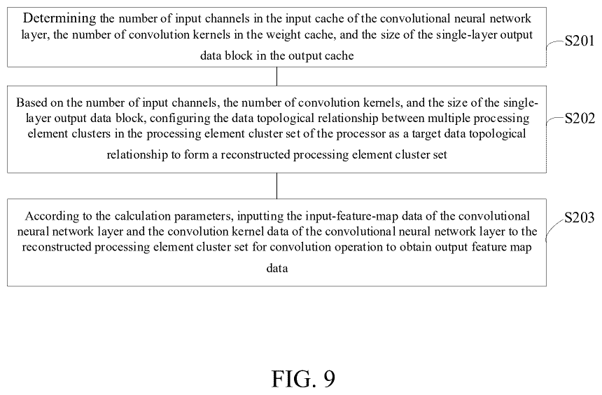

The present disclosure provides a neural network calculation method, and the method may be applied to a computer device. As shown in FIG. 9, the method includes S201 to S203.

At S201, the number of input channels in the input cache of the convolutional neural network layer, the number of convolution kernels in the weight cache, and the size of the single-layer output data block in the output cache, are determined.

At S202, based on the number of input channels, the number of convolution kernels, and the size of the single-layer output data block, the data topological relationship between multiple processing element clusters in the processing element cluster set of the processor is configured as a target data topological relationship to form a reconstructed processing element cluster set.

In some embodiments, taking the first layer of the VGG model as an example, the number of input channels of the first layer of the VGG model is 3. When the processing element cluster is 4×4×4 in size, the number of input channels may be divided by 4 and rounded to obtain a first correlation of 1 between the output cache blocks of each processing element cluster. It can be understood that the utilization of the processing unit may be increased to 0.75.

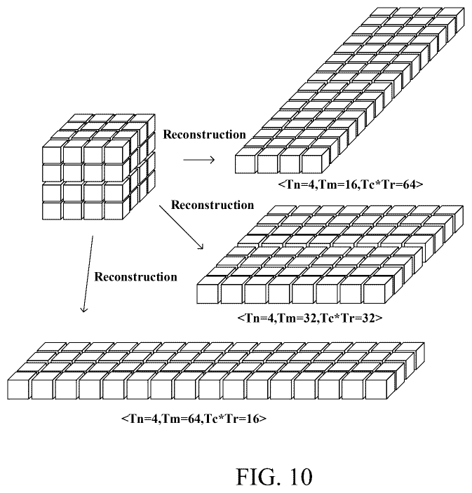

In some embodiments, as shown in FIG. 10, when the processing element cluster is 4×4×4 in size, when the number of input channels in the input cache Tₙ=4, the number of convolution kernels in the weight cache Tₘ=64, and the size of a single-layer output data block in the output cache T_{c}×Tᵣ=16, reconstruction may be performed to determine that the first correlation between the output cache blocks of the corresponding processing element clusters is 1, the second correlation between the input cache blocks of the processing element clusters is 16, and the third correlation between the weight cache blocks of the processing element clusters is 4. When the number of input channels in the input cache Tₙ=4, the number of convolution kernels in the weight cache Tₘ=32, and the size of a single-layer output data block in the output cache T_{c}×Tᵣ=32, reconstruction may be performed to determine that the first correlation between the output cache blocks of each corresponding processing element cluster is 1, the second correlation between the input cache blocks of each processing element cluster is 4, and the third correlation between the weight cache blocks of each processing element cluster is 4. When the number of input channels in the input cache area Tₙ=4, the number of convolution kernels in the weight cache area Tₘ=16, and the size of the single-layer output data block in the output cache area T_{c}×Tᵣ=64, reconstruction may be performed to determine that the first correlation between the output cache blocks of each corresponding processing element cluster is 1, the second correlation between the input cache blocks of each processing element cluster is 4, and the third correlation between the weight cache blocks of each processing element cluster is 16.

In some embodiments, the data topological relationship between multiple processing element clusters in the processing element cluster set of the processor may be configured as the target data topological relationship by the compiler.

At S203, according to the calculation parameters, the input-feature-map data of the convolutional neural network layer and the convolution kernel data of the convolutional neural network layer are input to the reconstructed processing element cluster set for convolution operation to obtain output feature map data.

In the present disclosure, the processing element cluster set may be reconstructed based on the number of input channels in the input cache of the convolutional neural network layer, the number of convolution kernels in the weight cache, and the size of the single-layer output data block in the output cache, which may optimize the convolutional neural network calculation layer by layer, improve the adaptability between each convolutional neural network layer and the processor element cluster set, and thus improve the utilization efficiency of the processing elements in the processor.

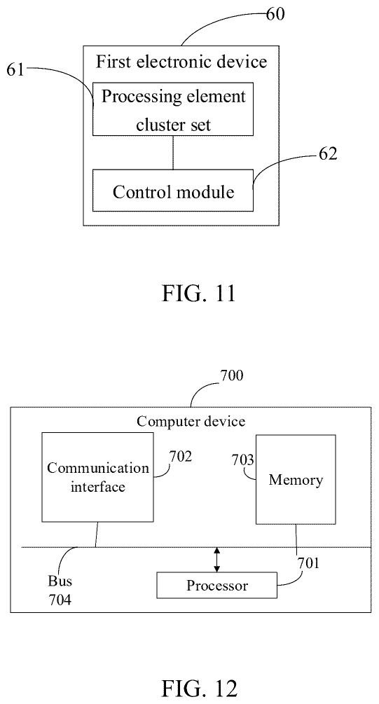

The present disclosure also provides a processor. As shown in FIG. 11, in one embodiment, the processor 60 may include a processing element cluster array 61 and a controller 62.

The processing element cluster set 61 may include multiple processing element clusters, and the data topological relationship between each of the processing element clusters may be re-constructible.

The controller 62 may be configured to: determine the calculation parameters of the convolutional neural network layer; based on the calculation parameters, configure the data topological relationship between the multiple processing element clusters in the processing element cluster set 61 as the target data topological relationship to form a reconstructed processing element cluster set 61; according to the calculation parameters, input the input-feature-map data of the convolutional neural network layer and the convolution kernel data of the convolutional neural network layer into the reconstructed processing element cluster set 61 for convolution operation to obtain output feature map data.

In some embodiments, the processor 60 may also include a cache module 63. The cache module 63 may include the data cache space and the calculation cache space. The data cache space may include an input cache area, a weight cache area, and an output cache area. The calculation cache space may include an input cache block, a weight cache block and an output cache block respectively possessed by each processing element cluster in the processing element cluster set 61. The calculation parameters may include blocking parameters. The controller 62 may be also used to: based on the blocking parameters, configure the mapping relationship between each cache block in the output cache area in the data cache space and the output cache block of each processing element cluster in the calculation cache space to a first mapping relationship, configure the mapping relationship between each cache block in the input cache area and the input cache block of each processing element cluster to a second mapping relationship, and configure the mapping relationship between each cache block in the weight cache area and the weight cache block of each processing element cluster to a third mapping relationship, to configure the data topological relationship between the multiple processing element clusters in the processing element cluster set 61 of the processor to the target data topological relationship, thereby forming the reconstructed processing element cluster set 61.

In some embodiments, the calculation parameters may include block parameters, and the output feature map data may include at least one output feature map data block. The controller 62 may be also used to: according to the block parameters, cache the input-feature-map data of the convolutional neural network layer and the convolution kernel data of the convolutional neural network layer in blocks to the data cache space of the cache module of the processor; and, for each cached input-feature-map data block and each convolution kernel data block, input the input-feature-map data block and the convolution kernel data block to the reconstructed processing element cluster set 61 according to the target data topological relationship for convolution operation, to obtain and cache the output feature map data block to the data cache space.

In some embodiments, the controller 62 may also be used to: according to the second mapping relationship and the third mapping relationship, read the input-feature-map data block in the input cache area and the convolution kernel data block in the weight cache area to the reconstructed processing element cluster set 61 for convolution operation, to obtain and cache the output feature map data block to the output cache area in the data cache space according to the first mapping relationship.

In some embodiments, the block parameters may include the number of input channels in the input cache area, the number of convolution kernels in the weight cache area, and the size of a single-layer output data block in the output cache area. The controller 62 may be also used to: determine the first correlation between the output cache blocks of each corresponding processing element cluster, the second correlation between the input cache blocks of each processing element cluster, and the third correlation between the weight cache blocks of each processing element cluster, based on the number of input channels in the input cache area, the number of convolution kernels in the weight cache area, and the size of a single-layer output data block in the output cache area; based on the first correlation, map the output cache block of each processing element cluster to at least one target cache block in the output cache area to obtain the first mapping relationship; based on the second correlation, map the input cache block of each processing element cluster to at least one target cache block in the input cache area to obtain the second mapping relationship; based on the third correlation, map the weight cache block of each processing element cluster to at least one target cache block in the weight cache area to obtain the third mapping relationship.

In some embodiments, the controller 62 may also be used to: obtain the input dimension parameter, output dimension parameter and convolution kernel dimension parameter of the convolution neural network layer; and, determine the calculation parameters of the convolution neural network layer based on the input dimension parameter, the output dimension parameter, the convolution kernel dimension parameter and the capacity of the data cache space.

In some embodiments, the controller 62 may also be used to: determine the data reuse mode and calculation parameters corresponding to the convolution neural network layer based on the input dimension parameter, the output dimension parameter, the convolution kernel dimension parameter and the capacity of the data cache space; and cache the input-feature-map data of the convolution neural network layer and the convolution kernel data of the convolution neural network layer in blocks into the data cache space according to the data reuse mode and the calculation parameters.

In some embodiments, the controller 62 may also be used to: for each candidate data reuse mode among at least one candidate data reuse mode determine the minimum processing energy consumption corresponding to the convolutional neural network layer under the candidate data reuse mode, and the candidate computing parameters corresponding to the minimum processing energy consumption based on the input dimension parameter, the output dimension parameter, the convolution kernel dimension parameter and the capacity of the data cache space; determine the data reuse mode corresponding to the convolutional neural network layer based on the minimum processing energy consumption corresponding to each of the candidate data reuse modes; and determine the candidate computing parameters corresponding to the data reuse mode as the computing parameters corresponding to the convolutional neural network layer.

The description of the above device embodiments is similar to the description of the above method embodiments, and has similar beneficial effects as the method embodiments. In some embodiments, the functions or modules included in the device provided in the embodiments of the present disclosure may be used to execute the method described in the above method embodiments. For technical details not disclosed in the device embodiments of the present disclosure, please refer to the description of the method embodiment of the present disclosure for understanding.

In the present disclosure, the above-mentioned neural network calculation method may be implemented in the form of a software function module and sold or used as an independent product, and may be stored in a computer-readable storage medium. Based on this understanding, the technical solution of the embodiments of the present disclosure may be essentially or partly reflected in the form of a software product that contributes to the relevant technology. The software product may be stored in a storage medium, including several instructions to enable a computer device (which may be a personal computer, server, or network device, etc.) to execute all or part of the methods described in each embodiment of the present disclosure. The aforementioned storage medium may include various media that can store program codes, such as a flash disk, a mobile hard disk, a read-only memory (ROM), a magnetic disk or an optical disk. In this way, the embodiments of the present disclosure are not limited to any specific hardware, software or firmware, or any combination of hardware, software, and firmware.

The present disclosure also provides a computer device, including a memory and a processor. The memory may be configured to store a computer program that is able to be executed by the processor. When executing the computer program, the processor may implement any method provided by various embodiments of the present disclosure.

The present disclosure also provides a computer-readable storage medium, on which a computer program is stored. When the computer program is executed by a processor, a device where the processor is located may implement any method provided by various embodiments of the present disclosure. The computer-readable storage medium may be transient or non-transient.

The present disclosure also provides a computer program, including computer-readable codes. When the computer-readable codes are executed in a computer device, a processor of the computer device may implement any method provided by various embodiments of the present disclosure.

The present disclosure also provides a computer program product, which includes a non-transient computer-readable storage medium storing a computer program. When the computer program is executed by a processor, a device where the processor is located may implement any method provided by various embodiments of the present disclosure. The computer program product may be implemented specifically by hardware, software, or a combination thereof. In some embodiments, the computer program product may be specifically embodied as a computer storage medium. In other embodiments, the computer program product may be specifically embodied as a software product, such as a software development kit (SDK) and the like.

The description of each embodiment above tends to emphasize the differences between the embodiments, and the same or similar aspects can be referenced to each other. The description of the above device, storage medium, computer program and computer program product embodiments is similar to the description of the above method embodiments, and has similar beneficial effects as the method embodiments. For technical details not disclosed in the embodiments of the device, storage medium, computer program and computer program product of the present disclosure, please refer to the description of the method embodiments of the present disclosure.

FIG. 12 is a schematic diagram of a hardware entity of a computer device provided by one embodiment of the present disclosure. As shown in FIG. 12, the hardware entity of the computer device 700 includes: a processor 701, a communication interface 702 and a memory 703. The processor 701 may be configured to generally control the overall operation of the computer device 700. The communication interface 702 may be used to enable the computer device to communicate with other terminals or servers through a network. The memory 703 may be configured to store instructions and applications executable by the processor 701, and also cache data to be processed or processed by the processor 701 and each module in the computer device 700 (for example, image data, audio data, voice communication data and video communication data). The memory 703 may be implemented by a flash memory (FLASH) or a random access memory (RAM). Data may be transmitted between the processor 701, the communication interface 702 and the memory 703 through the bus 704. When the processor 701 executes the program, the computer device may be configured to implement any method provided by various embodiments of the present disclosure. The memory 703 may also include the cache module provided in the above embodiments.

In the present disclosure, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: a plurality of units or components may be combined, or may be integrated into another system, or some features may be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to a plurality of network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units may be integrated into one unit. The above-mentioned integration units may be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, read only memories (ROMs), magnetic disks, optical disks or other media that may store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that may store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A neural network calculation method comprising:
determining calculation parameters of convolutional neural network layers;
based on the calculation parameters, configuring a data topological relationship between a plurality of processing element clusters in a processing element cluster set of a processor as a target data topological relationship, to form a reconstructed processing element cluster set; and
inputting input-feature-map data of the convolutional neural network layers and convolution kernel data of the convolutional neural network layers into the reconstructed processing element cluster set for convolution operation based on the calculation parameters to obtain output feature map data.

2. The method according to claim 1, wherein:
the calculation parameters include block parameters, and the output feature map data includes at least one output feature map data block; and
inputting the input-feature-map data of the convolutional neural network layers and the convolution kernel data of the convolutional neural network layers into the reconstructed processing element cluster set for convolution operation based on the calculation parameters to obtain the output feature map data, includes:
according to the block parameters, caching the input-feature-map data of the convolutional neural network layers and the convolution kernel data of the convolutional neural network layers into a data cache space of a cache module of the processor in blocks; and
for each input-feature-map data block and each convolution kernel data block that are cached, inputting the input-feature-map data block and the convolution kernel data block into the reconstructed processing element cluster set according to the target data topological relationship for convolution operation, to obtain and cache the output feature map data block into the data cache space.

3. The method according to claim 2, wherein:
the cache module includes the data cache space and a calculation cache space;
the data cache space includes an input cache area, a weight cache area, and an output cache area;
the calculation cache space includes an input cache block, a weight cache block, and an output cache block respectively possessed by each processing element cluster in the processing element cluster set;
based on the calculation parameters, configuring the data topological relationship between the plurality of processing element clusters in the processing element cluster set of the processor as the target data topological relationship to form the reconstructed processing element cluster set, includes:
based on the block parameters, configuring a mapping relationship between each cache block in the output cache area in the data cache space and the output cache block of each processing element cluster in the calculation cache space to a first mapping relationship, configuring a mapping relationship between each cache block in the input cache area and the input cache block of each processing element cluster to a second mapping relationship, and configuring a mapping relationship between each cache block in the weight cache area and the weight cache block of each processing element cluster to a third mapping relationship, to configure the data topological relationship between the plurality of processing element clusters in the processing element cluster set of the processor as the target data topological relationship to form the reconstructed processing element cluster set; and
inputting the input-feature-map data block and the convolution kernel data block into the reconstructed processing element cluster set according to the target data topological relationship for convolution operation, to obtain and cache the output feature map data block in the data cache space, includes:
according to the second mapping relationship and the third mapping relationship, respectively reading the input-feature-map data block in the input cache area and the convolution kernel data block in the weight cache area into the reconstructed processing element cluster set for convolution operation, to obtain and cache the output feature map data to the output cache area in the data cache space according to the first mapping relationship.

4. The method according to claim 3, wherein:
the block parameters include a number of input channels in the input cache area, a number of convolution kernels in the weight cache area, and a size of a single-layer output data block in the output cache area; and
based on the block parameters, configuring the mapping relationship between each cache block in the output cache area in the data cache space and the output cache block of each processing element cluster in the calculation cache space to the first mapping relationship, configuring the mapping relationship between each cache block in the input cache area and the input cache block of each processing element cluster to the second mapping relationship, and configuring the mapping relationship between each cache block in the weight cache area and the weight cache block of each processing element cluster to the third mapping relationship, includes:
based on the number of input channels in the input cache area, the number of convolution kernels in the weight cache area, and the single-layer output data block size in the output cache area, respectively determining a first correlation between the output cache block of each processing element cluster, a second correlation between the input cache block of each processing element cluster, and a third correlation between the weight cache block of each processing element cluster;
based on the first correlation, mapping the output cache block of each processing element cluster to at least one target cache block in the output cache area to obtain the first mapping relationship;
based on the second correlation, mapping the input cache block of each processing element cluster to at least one target cache block in the input cache area to obtain the second mapping relationship; and
based on the third correlation, mapping the weight cache block of each processing element cluster to at least one target cache block in the weight cache area to obtain the third mapping relationship.

5. The method according to claim 2, wherein, determining the calculation parameters of the convolution neural network layers, includes:
obtaining input dimension parameters, output dimension parameters and convolution kernel dimension parameters of the convolution neural network layers; and
determining the calculation parameters of the convolution neural network layer based on the input dimension parameters, the output dimension parameters, the convolution kernel dimension parameters and the capacity of the data cache space.

6. The method according to claim 5, wherein:
determining the calculation parameters of the convolution neural network layer based on the input dimension parameters, the output dimension parameters, the convolution kernel dimension parameters and the capacity of the data cache space, includes: based on the input dimension parameters, the output dimension parameters, the convolution kernel dimension parameters and the capacity of the data cache space, determining a data reuse mode and the calculation parameters corresponding to the convolution neural network layers; and
caching the input-feature-map data of the convolution neural network layers and the convolution kernel data of the convolution neural network layers in blocks into the data cache space of the cache module of the processor according to the block parameters, includes: according to the data reuse mode and the calculation parameters, caching the input-feature-map data of the convolution neural network layers and the convolution kernel data of the convolution neural network layers in blocks into the data cache space.

7. The method according to claim 6, wherein:
based on the input dimension parameters, the output dimension parameters, the convolution kernel dimension parameters and the capacity of the data cache space, determining the data reuse mode and the calculation parameters corresponding to the convolution neural network layers, includes:
for each candidate data reuse mode among at least one candidate data reuse mode, determining minimum processing energy consumption corresponding to the convolutional neural network layers under the candidate data reuse mode and the candidate calculation parameters corresponding to the minimum processing energy consumption, based on the input dimension parameters, the output dimension parameters, the convolution kernel dimension parameters and the capacity of the data cache space;
determining the data reuse mode corresponding to the convolutional neural network layers based on the minimum processing energy consumption corresponding to each of the at least one candidate data reuse mode; and
determining the candidate calculation parameters corresponding to the data reuse mode as the calculation parameters of the convolutional neural network layers.

8. A processor comprising a processing element cluster set and a controller, wherein:
the processing element cluster set includes a plurality of processing element clusters, and a data topological relationship between the processing element clusters is re-constructible; and
the controller is configured to:
determine calculation parameters of convolutional neural network layers;
based on the calculation parameters, configure the data topological relationship between the plurality of processing element clusters in the processing element cluster set as a target data topological relationship, to form a reconstructed processing element cluster set; and
input input-feature-map data of the convolutional neural network layers and convolution kernel data of the convolutional neural network layers into the reconstructed processing element cluster set for convolution operation based on the calculation parameters to obtain output feature map data.

9. The processor according to claim 8, further including a cache module, wherein:
the cache module includes a data cache space and a calculation cache space;
the data cache space includes an input cache area, a weight cache area, and an output cache area;
the calculation cache space includes an input cache block, a weight cache block, and an output cache block respectively possessed by each of the plurality of processing unit arrays in the processing unit array set;
the calculation parameters include block parameters; and
the controller is further configured to: based on the block parameters, configure a mapping relationship between each cache block in the output cache area in the data cache space and the output cache block of each processing element cluster in the calculation cache space to a first mapping relationship, configure a mapping relationship between each cache block in the input cache area and the input cache block of each processing element cluster to a second mapping relationship, and configure a mapping relationship between each cache block in the weight cache area and the weight cache block of each processing element cluster to a third mapping relationship, to configure the data topological relationship between the plurality of processing element clusters in the processing element cluster set of the processor as the target data topological relationship to form the reconstructed processing element cluster set.

10. The processor according to claim 9, wherein:
the block parameters include a number of input channels in the input cache area, a number of convolution kernels in the weight cache area, and a size of a single-layer output data block in the output cache area; and
the controller is further configured to:
based on the number of input channels in the input cache area, the number of convolution kernels in the weight cache area, and the single-layer output data block size in the output cache area, respectively determine a first correlation between the output cache block of each processing element cluster, a second correlation between the input cache block of each processing element cluster, and a third correlation between the weight cache block of each processing element cluster;
based on the first correlation, map the output cache block of each processing element cluster to at least one target cache block in the output cache area to obtain the first mapping relationship;
based on the second correlation, map the input cache block of each processing element cluster to at least one target cache block in the input cache area to obtain the second mapping relationship; and
based on the third correlation, map the weight cache block of each processing element cluster to at least one target cache block in the weight cache area to obtain the third mapping relationship.

11. The processor according to claim 9, wherein the controller is further configured to:
obtain input dimension parameters, output dimension parameters and convolution kernel dimension parameters of the convolution neural network layers; and
determine the calculation parameters of the convolution neural network layer based on the input dimension parameters, the output dimension parameters, the convolution kernel dimension parameters and the capacity of the data cache space.

12. The processor according to claim 11, wherein the controller is further configured to:
based on the input dimension parameters, the output dimension parameters, the convolution kernel dimension parameters and the capacity of the data cache space, determine a data reuse mode and the calculation parameters corresponding to the convolution neural network layers; and
according to the data reuse mode and the calculation parameters, cache the input-feature-map data of the convolution neural network layers and the convolution kernel data of the convolution neural network layers in blocks into the data cache space.

13. The processor according to claim 12, wherein the controller is further configured to:
for each candidate data reuse mode among at least one candidate data reuse mode, determine minimum processing energy consumption corresponding to the convolutional neural network layers under the candidate data reuse mode and the candidate calculation parameters corresponding to the minimum processing energy consumption, based on the input dimension parameters, the output dimension parameters, the convolution kernel dimension parameters and the capacity of the data cache space;
determine the data reuse mode corresponding to the convolutional neural network layers based on the minimum processing energy consumption corresponding to each of the at least one candidate data reuse mode; and
determine the candidate calculation parameters corresponding to the data reuse mode as the calculation parameters of the convolutional neural network layers.

14. A computer device, comprising:
one or more processors and a memory containing a computer program that, when being executed, causes the one or more processors to perform:
determining calculation parameters of convolutional neural network layers;
based on the calculation parameters, configuring a data topological relationship between a plurality of processing element clusters in a processing element cluster set of a processor as a target data topological relationship, to form a reconstructed processing element cluster set; and
inputting input-feature-map data of the convolutional neural network layers and convolution kernel data of the convolutional neural network layers into the reconstructed processing element cluster set for convolution operation based on the calculation parameters to obtain output feature map data.

15. The device according to claim 14, wherein:
the calculation parameters include block parameters, and the output feature map data includes at least one output feature map data block; and
the one or more processors are further configured to perform:
according to the block parameters, caching the input-feature-map data of the convolutional neural network layers and the convolution kernel data of the convolutional neural network layers into a data cache space of a cache module of the processor in blocks; and
for each input-feature-map data block and each convolution kernel data block that are cached, inputting the input-feature-map data block and the convolution kernel data block into the reconstructed processing element cluster set according to the target data topological relationship for convolution operation, to obtain and cache the output feature map data block into the data cache space.

16. The device according to claim 15, wherein:
the cache module includes the data cache space and a calculation cache space;
the data cache space includes an input cache area, a weight cache area, and an output cache area;
the calculation cache space includes an input cache block, a weight cache block, and an output cache block respectively possessed by each processing element cluster in the processing element cluster set;
the one or more processors are further configured to perform:
based on the block parameters, configuring a mapping relationship between each cache block in the output cache area in the data cache space and the output cache block of each processing element cluster in the calculation cache space to a first mapping relationship, configuring a mapping relationship between each cache block in the input cache area and the input cache block of each processing element cluster to a second mapping relationship, and configuring a mapping relationship between each cache block in the weight cache area and the weight cache block of each processing element cluster to a third mapping relationship, to configure the data topological relationship between the plurality of processing element clusters in the processing element cluster set of the processor as the target data topological relationship to form the reconstructed processing element cluster set; and
according to the second mapping relationship and the third mapping relationship, respectively reading the input-feature-map data block in the input cache area and the convolution kernel data block in the weight cache area into the reconstructed processing element cluster set for convolution operation, to obtain and cache the output feature map data to the output cache area in the data cache space according to the first mapping relationship.

17. The device according to claim 16, wherein:
the block parameters include a number of input channels in the input cache area, a number of convolution kernels in the weight cache area, and a size of a single-layer output data block in the output cache area; and
the one or more processors are further configured to perform:
based on the number of input channels in the input cache area, the number of convolution kernels in the weight cache area, and the single-layer output data block size in the output cache area, respectively determining a first correlation between the output cache block of each processing element cluster, a second correlation between the input cache block of each processing element cluster, and a third correlation between the weight cache block of each processing element cluster;
based on the first correlation, mapping the output cache block of each processing element cluster to at least one target cache block in the output cache area to obtain the first mapping relationship;
based on the second correlation, mapping the input cache block of each processing element cluster to at least one target cache block in the input cache area to obtain the second mapping relationship; and
based on the third correlation, mapping the weight cache block of each processing element cluster to at least one target cache block in the weight cache area to obtain the third mapping relationship.

18. The device according to claim 15, wherein the one or more processors are further configured to perform:
obtaining input dimension parameters, output dimension parameters and convolution kernel dimension parameters of the convolution neural network layers; and
determining the calculation parameters of the convolution neural network layer based on the input dimension parameters, the output dimension parameters, the convolution kernel dimension parameters and the capacity of the data cache space.

19. The device according to claim 18, wherein the one or more processors are further configured to perform:
based on the input dimension parameters, the output dimension parameters, the convolution kernel dimension parameters and the capacity of the data cache space, determining a data reuse mode and the calculation parameters corresponding to the convolution neural network layers; and
according to the data reuse mode and the calculation parameters, caching the input-feature-map data of the convolution neural network layers and the convolution kernel data of the convolution neural network layers in blocks into the data cache space.

20. The device according to claim 19, wherein the one or more processors are further configured to perform:
for each candidate data reuse mode among at least one candidate data reuse mode, determine minimum processing energy consumption corresponding to the convolutional neural network layers under the candidate data reuse mode and the candidate calculation parameters corresponding to the minimum processing energy consumption, based on the input dimension parameters, the output dimension parameters, the convolution kernel dimension parameters and the capacity of the data cache space;
determining the data reuse mode corresponding to the convolutional neural network layers based on the minimum processing energy consumption corresponding to each of the at least one candidate data reuse mode; and
determining the candidate calculation parameters corresponding to the data reuse mode as the calculation parameters of the convolutional neural network layers.
